(19) United States
(12) Patent Application Publication
(10) Pub. No.: US 2026/0050821 A1
(43) Pub. Date: Feb. 19, 2026

(54) SYSTEMS FOR AND METHODS OF CENTRAL PLANT OPTIMIZATION USING ARTIFICIAL INTELLIGENCE

(71) Applicant: Tyco Fire & Security GmbH, Neuhausen am Rheinfall (CH)

(72) Inventors: WenSu Lu, Buffalo Grove, IL (US); Matthew J. Asmus, Watertown, WI (US); Yonglun Li, Waukesha, WI (US); Vivek Vishnu Gupta, Menomonee Falls, WI (US)

(73) Assignee: Tyco Fire & Security GmbH, Neuhausen am Rheinfall (CH)

(21) Appl. No.: 18/807,376

(22) Filed: Aug. 16, 2024

(51) Int. Cl. G06N 20/00; G05B 13/02; G06N 5/01

(52) U.S. Cl. CPC G06N 20/00; G05B 13/0265; G06N 5/01

(57) ABSTRACT

A method for improving the operations of a central plant. Historical operational data of the plant is used to train various equipment models of the building. Using the equipment models optimization problems are generated for various operating conditions. Training data sets including the operating conditions and the respective solutions to the optimization problems are formed. An artificial intelligence model is trained to approximate the solutions to the optimization problem. The artificial intelligence model is used generate an operating point for current operating conditions and the operating point is used to control the equipment of the plant.

### BACKGROUND

The present disclosure relates to efficiently operating a central plant for maintaining comfort within a building or group of buildings. More specifically, the present disclosure relates to efficiently operating a central plant using artificial intelligence (AI) models.

Efficient operating points of a central plant depend on several factors. The best operating point may depend on weather, building usage, equipment models, equipment availability, and energy cost considerations. AI models can be trained to consider the various factors driving plant efficiency and determine efficient operating points that satisfy device and load constraints. The AI models may have varying architectures to provide models that describe equipment behavior and/or the behavior of groups of equipment. Using the equipment models an optimization problem can be solved that provides efficient operating points for various plant conditions. Additional AI models may be trained to determine to approximate the solutions of the optimization problem. Inference may be performed in resource constrained equipment controllers to provide efficient operations, without the expense or potential for communication issues present in cloud computing.

### SUMMARY OF THE INVENTION

An embodiment of the present disclosure relates to a method for improving efficiency of a central plant, the method includes generating an optimization problem. The optimization problem includes a constraint based on at least one equipment-level artificial intelligence model or an objective function based on the at least one equipment-level artificial intelligence model. The method also includes solving the optimization problem to obtain central plant optimizer training data. The method also includes training a plant-level artificial intelligence model to approximate solutions to the optimization problem using the central plant optimizer training data. The method also includes operating equipment of the central plant based on current plant operating targets generated by evaluating the plant-level artificial intelligence model.

In some embodiments, the at least one equipment-level artificial intelligence model relates controlled operating conditions of equipment to energy usage of the equipment and the decision variables of the optimization problem include at least one of the controlled operating conditions of the equipment.

In some embodiments, the method also includes providing uncontrolled operating conditions of the central plant. Solving the optimization problem includes at least one of (i) using the uncontrolled operating conditions of the central plant to generate a second constraint or (ii) basing the objective function on the uncontrolled operating conditions of the central plant. The central plant optimizer training data includes respective plant operating targets for the uncontrolled operating conditions of the central plant.

In some embodiments, the current plant operating targets include at least one of a target condenser water flow through all a chiller, a target exiting condenser water temperature for the chiller, a target exiting condenser water temperature for a cooling tower, a target exiting evaporator water temperature for the chiller, a target speed for a condenser water pump, or a target speed for a cooling tower fan.

In some embodiments, the uncontrolled operating conditions of the central plant include at least one of a required production of the central plant, an outdoor air temperature, or an outdoor air wet-bulb temperature.

In some embodiments, training the at least one equipment-level artificial intelligence model, generating the central plant optimizer training data, and training the plant-level artificial intelligence model are performed within a cluster of computers and operating the equipment of the central plant is performed by an edge device.

In some embodiments, a form of the plant-level artificial intelligence model is stored in the edge device and parameters for the plant-level artificial intelligence model are provided to the edge device from the cluster of computers.

In some embodiments, the method also includes receiving recent operational data and training the at least one equipment-level artificial intelligence model using the recent operational data.

In some embodiments, the method also includes using the at least one equipment-level artificial intelligence model to estimate savings realized by operating the equipment according to the current plant operating targets.

An embodiment of the present disclosure relates to a system for improving efficiency of a central plant. The system includes one or more memory devices having instructions stored thereon that, when executed by one or more processors, cause the one or more processors to perform operations. The operations include generating an optimization problem. The optimization problem includes a constraint based on at least one equipment-level artificial intelligence model or an objective function based on the at least one equipment-level artificial intelligence model. The operations also include solving the optimization problem to obtain central plant optimizer training data. The operations also include training a plant-level artificial intelligence model to approximate solutions to the optimization problem using the central plant optimizer training data. The operations also include operating equipment of the central plant based on current plant operating targets generated by evaluating the plant-level artificial intelligence model.

In some embodiments, the operations also include providing uncontrolled operating conditions of the central plant. Solving the optimization problem includes at least one of (i) using the uncontrolled operating conditions of the central plant to generate a second constraint or (ii) basing the objective function on the uncontrolled operating conditions of the central plant. The central plant optimizer training data includes respective plant operating targets for the uncontrolled operating conditions of the central plant.

In some embodiments, the current plant operating targets includes at least one of a target condenser water flow through all a chiller, a target exiting condenser water temperature for the chiller, a target exiting condenser water temperature for a cooling tower, a target exiting evaporator water temperature for the chiller, a target speed for a condenser water pump, or a target speed for a cooling tower fan.

In some embodiments, the uncontrolled operating conditions of the central plant include at least one of a required production of the central plant, an outdoor air temperature, or an outdoor air wet-bulb temperature.

In some embodiments, training the at least one equipment-level artificial intelligence model, generating the central plant optimizer training data, and training the plant-level artificial intelligence model is performed within a cluster of computers and operating the equipment of the central plant is performed by an edge device.

In some embodiments, a form of the plant-level artificial intelligence model is stored in the edge device and parameters for the plant-level artificial intelligence model are provided to the edge device from the cluster of computers.

In some embodiments, the operations also include using the at least one equipment-level artificial intelligence model to estimate savings realized by operating the equipment according to the current plant operating targets.

An embodiment of the present disclosure relates to a building controller configured to improve efficiency of a central plant. The building controller includes one or more memory devices having a model form of a plant-level artificial intelligence model stored thereon. The plant-level artificial intelligence model is configured to accept uncontrolled operating conditions of the central plant as an input and produce plant operating targets as an output. The one or more memory devices having instructions stored thereon that, when executed by one or more processors, cause the one or more processors to perform operations. The operations include evaluating current uncontrolled operating conditions of the central plant using the plant-level artificial intelligence model to obtain current plant operating targets. The operations also include operating the central plant based on the current plant operating targets. The plant-level artificial intelligence model is trained to approximate solutions to an optimization problem using central plant optimizer training data. The central plant optimizer training data is created by solving the optimization problem to obtain respective plant operating targets for uncontrolled operating conditions of the plant.

In some embodiments, the operations also include receiving parameters for the plant-level artificial intelligence model. The operations also include receiving current sensor data comprising current uncontrolled operating conditions of the central plant; and the operations also include receiving recent operational data and training the plant-level artificial intelligence model using the recent operational data.

In some embodiments, the operations also include using the plant-level artificial intelligence model to estimate savings realized by operating the central plant according to the current plant operating targets.

In some embodiments, the current plant operating targets include at least one of a target condenser water flow through all a chiller, a target exiting condenser water temperature for the chiller, a target exiting condenser water temperature for a cooling tower, a target exiting evaporator water temperature for the chiller, a target speed for a condenser water pump, or a target speed for a cooling tower fan.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a heating, ventilating, and air conditioning (HVAC) system, according to some embodiments.

FIG. 2 is a block diagram of a building management system (BMS) which can be used to monitor and control the building and HVAC system of FIG. 1, according to some embodiments.

FIG. 3 is a block diagram illustrating the BMS of FIG. 2 in greater detail, according to some embodiments.

FIG. 4 is a is a block diagram of a BMS that can be implemented in the building of FIG. 1, according to some embodiments.

FIG. 5A is a depiction of a chiller assembly that can be implemented in the HVAC system of FIG. 1, according to some embodiments.

FIG. 5B is a block diagram of a central plant optimization system that can be implemented in the HVAC system of FIG. 1, according to some embodiments.

FIG. 6 is a block diagram of a system for efficiently operating a central plant, according to some embodiments.

FIG. 7 is a block diagram of a control logic hierarchy, according to some embodiments.

FIG. 8 is an equipment-level artificial intelligence model illustrating the inputs and outputs, according to some embodiments.

FIG. 9 is a plant-level artificial intelligence model illustrating the inputs and outputs, according to some embodiments.

FIG. 10 is a plot illustrating the power usage of a pump, tower, and chiller as a target operating point is varied, according to some embodiments.

FIG. 11 is a block diagram of the flow of information through the operations of a system for efficiently operating a central plant, according to some embodiments.

FIG. 12A is a flow diagram for efficiently operating central plant equipment using artificial intelligence models, according to some embodiments.

FIG. 12B is a flow diagram for generating an optimization problem using equipment-level artificial intelligence models, according to some embodiments.

FIG. 12C is another flow diagram for generating an optimization problem using equipment-level artificial intelligence models, according to some embodiments.

FIG. 13 is a flow diagram for efficiently operating central plant equipment with an automatic and advisory mode, according to some embodiments.

FIG. 14 is a flow diagram for adjusting the parameters of an artificial intelligence model for efficiently operating central plant equipment, according to some embodiments.

### DETAILED DESCRIPTION

### Overview

Referring generally to the FIGURES, a central plant optimization system using artificial intelligence models is shown, according to some embodiments. The HVAC devices may operate within a building management system (BMS). A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof. The BMS described herein provides a system architecture that embeds artificial intelligence models to perform central plant optimization.

### Building Management System and HVAC System

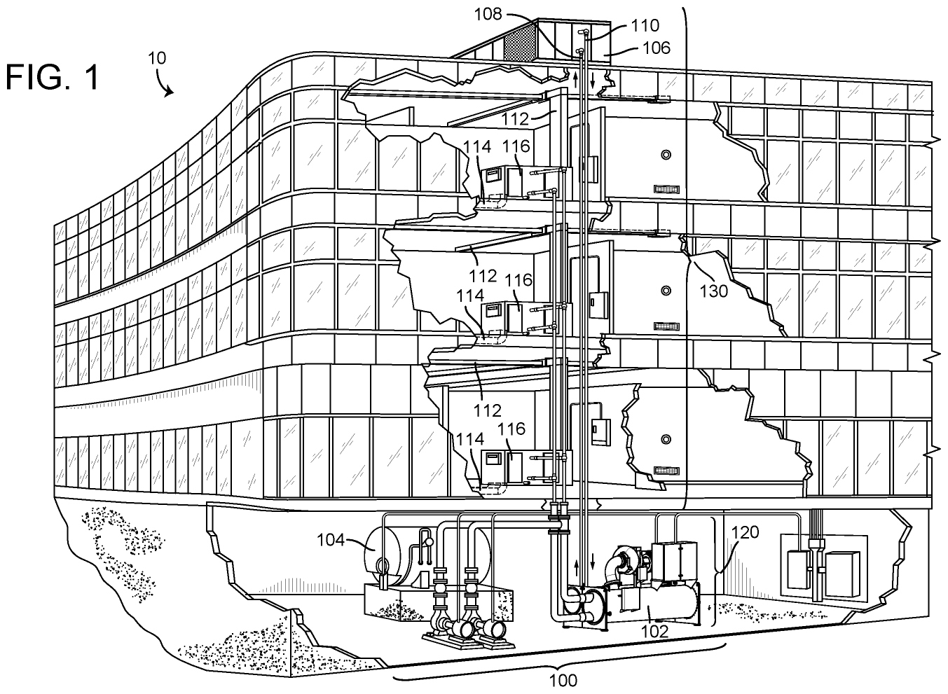

Referring now to FIGS. 1-4, an exemplary building management system (BMS) and HVAC system in which the systems and methods of the present invention can be implemented are shown, according to some embodiments. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

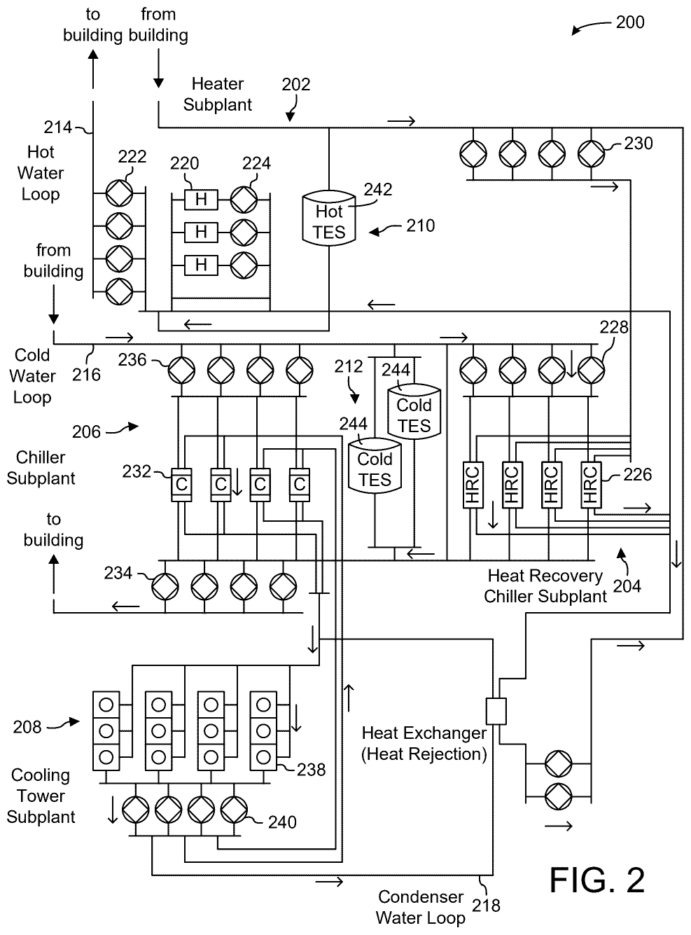

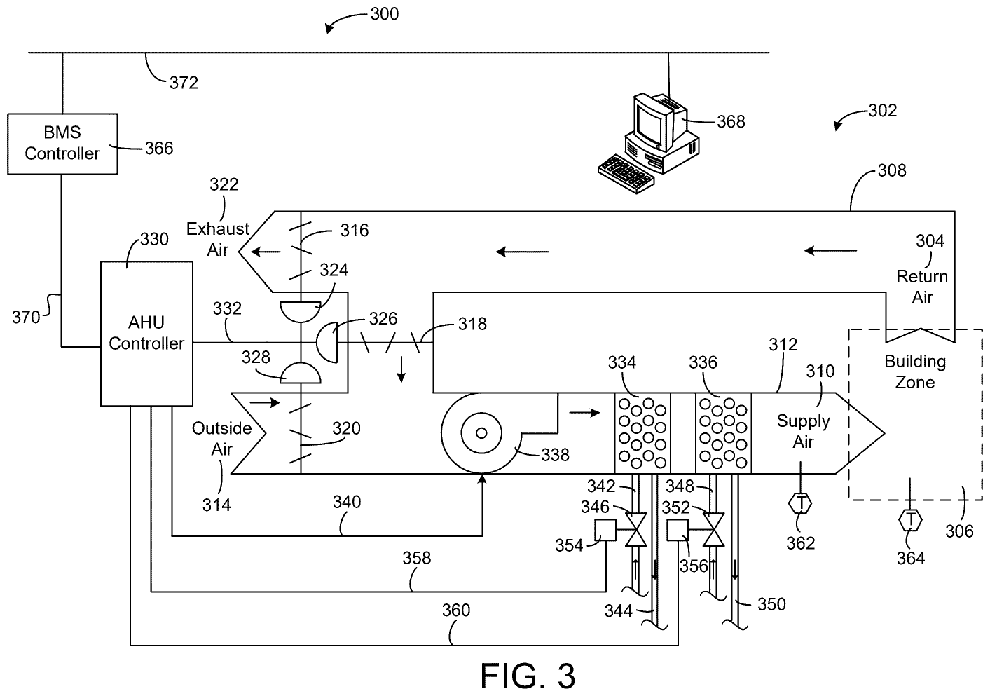

The BMS that serves building 10 includes an HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 may include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve the thermal energy loads. In other embodiments, subplants 202-212 may provide heating and/or cooling directly to the building or campus without requiring an intermediate heat transfer fluid. These and other variations to waterside system 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 may include more, fewer, or different types of devices and/or subplants based on the particular configuration of waterside system 200 and the types of loads served by waterside system 200.

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 may include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals may include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 may include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

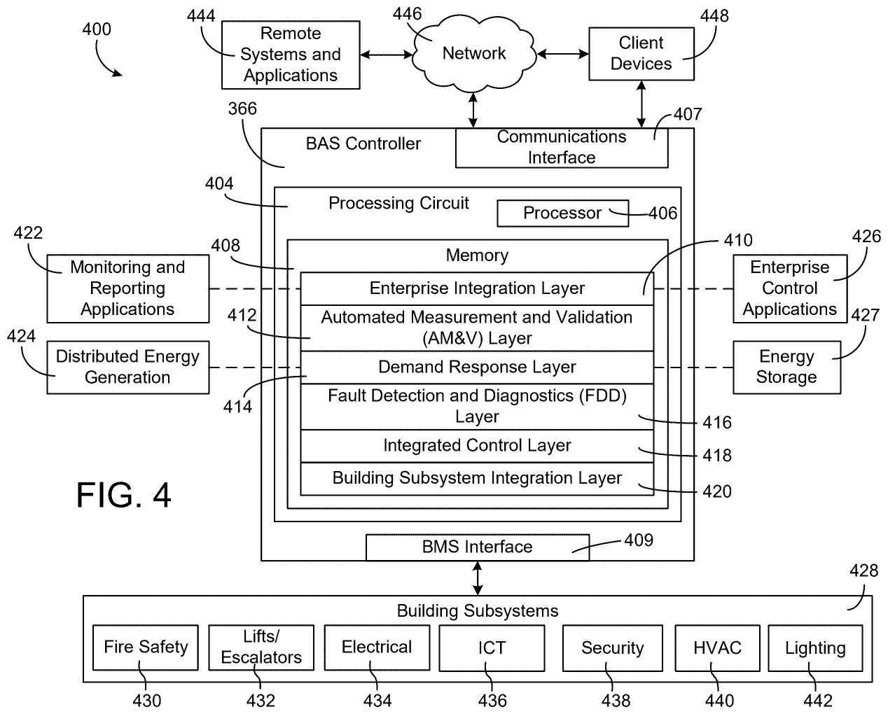

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 may include any number of devices, controllers, and connections for completing its individual functions and control activities. HVAC subsystem 440 may include many of the same components as HVAC system 100, as described with reference to FIGS. 1-3. For example, HVAC subsystem 440 may include and number of chillers, heaters, handling units, economizers, field controllers, supervisory controllers, actuators, temperature sensors, and/or other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a WiFi transceiver for communicating via a wireless communications network. In another example, one or both of interfaces 407, 409 may include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 may include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 may include measured or calculated values that exhibit statistical characteristics and provide information about how the corresponding system or process (e.g., a temperature control process, a flow control process, etc.) is performing in terms of error from its setpoint.

These processes can be examined by FDD layer 416 to expose when the system begins to degrade in performance and alert a user to repair the fault before it becomes more severe.

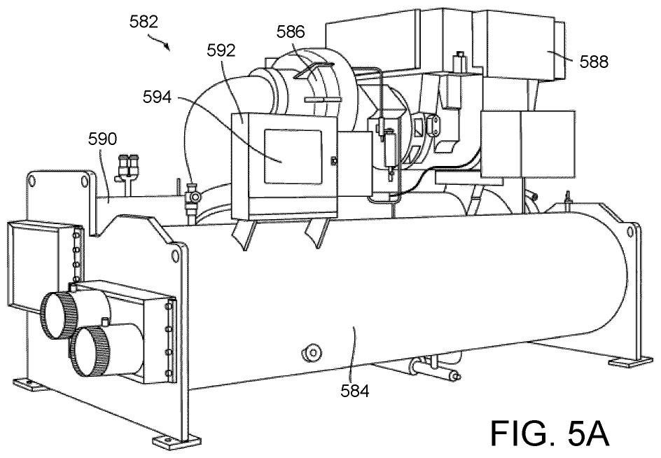

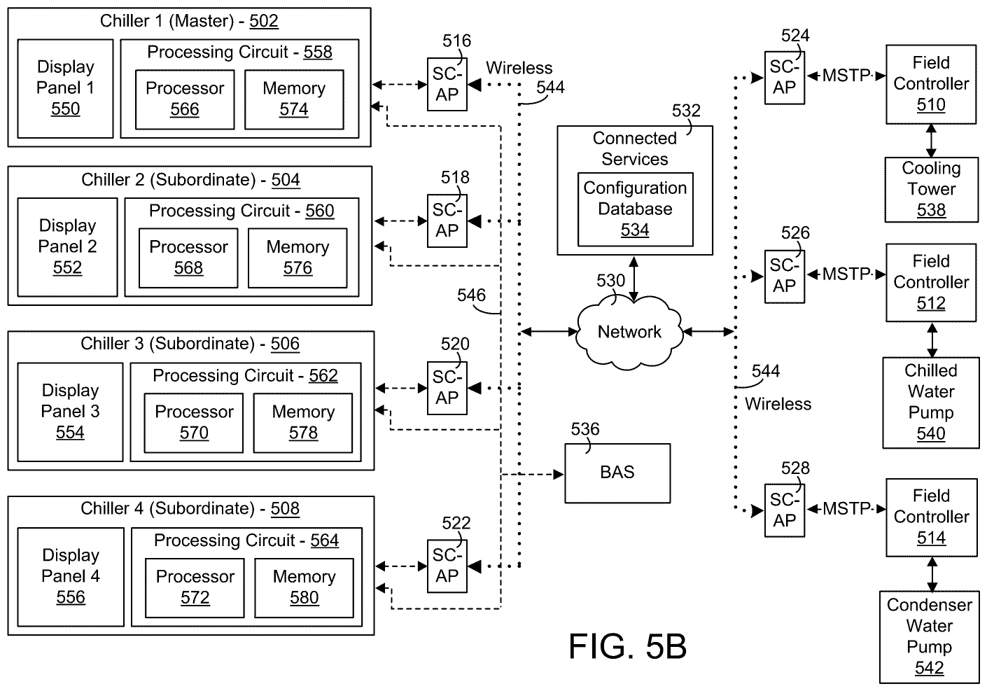

Referring now to FIG. 5A, a chiller 582 is depicted. Chiller 582 is shown to include evaporator 584, which provides a heat exchange between the fluid returned from the HVAC system and another fluid, such as a refrigerant. The refrigerant in evaporator 584 of chiller 582 may remove heat from the chilled fluid during the evaporation process, thereby cooling the chilled fluid. The refrigerant may absorb heat from the chilled fluid and change from a boiling liquid and vapor state to vapor inside evaporator 584. The chilled fluid may then be circulated back to an air handling unit via piping, as illustrated in FIG. 1, for subsequent heat exchange with the load.

Suction may cause the refrigerant vapor to flow from evaporator 584 into compressor 586 of chiller 582. Compressor 586 may include a rotating impeller (or another compressor mechanism such as a screw compressor, reciprocating compressor, centrifugal compressor, etc.) that increases the pressure and temperature of the refrigerant vapor and discharges it into condenser 590. The impeller may be driven by motor 588, which may have a variable speed drive (e.g., variable frequency drive). The variable speed drive may control the speed of the motor 588 by varying the AC waveform provided to the motor. The impeller may further include or be coupled to an actuator that controls the position of pre-rotation vanes at the entrance to the impeller of compressor 586.

The discharge from compressor 586 may pass through a discharge baffle into condenser 590 and through a sub-cooler, controllably reducing the discharge back into liquid form. The liquid may then pass through a flow control orifice and through an oil cooler to return to evaporator 584 to complete the cycle. In the embodiment shown in FIG. 5A, the chiller 582 further includes a controller 592 coupled to an electronic display 594 (e.g., a touch screen) at which settings for the chiller 582 (e.g., the speed of motor 588, the angle of the pre-rotation vanes) may be adjusted to vary the flow of refrigerant through the chiller 582. Electronic display 594 may also display information related to the central plan optimization system, thus converting the chiller device into a “super chiller.” A super chiller may be configured to control the chiller plant. For example, a super chiller may provide chiller plant or central plant optimization and/or execute any of the functionality described in later sections of the present disclosure to provide functionality related to central plant optimization. In other embodiments, multiple super chillers may exist in the chiller plant in a cooperative mode.

Turning now to FIG. 5B, a central plant optimization system (CPOS) 500 is depicted. In various embodiments, system 500 may include a subsystem or component of HVAC system 100. CPOS 500 is shown to include multiple chillers (e.g., chiller 502, chiller 504, chiller 506, and chiller 508). In some embodiments, chillers 502-508 are identical or substantially similar to chiller 582, described above with reference to FIG. 5A. Chillers 502-508 are shown to be communicably coupled to BAS 536 via network 546. In some embodiments, BAS 536 is identical or substantially similar to BAS controller 366 described above with reference to FIG. 4. For example, according to an exemplary embodiment, BAS 536 is a METASYS® brand building automation system, as sold by Johnson Controls, Inc. In some embodiments, chillers 502-508 may communicate with BAS 526 via a BACnet communications protocol.

CPOS 500 is further shown to include one or more cooling towers (e.g., cooling tower 538), one or more chilled water pumps (e.g., chilled water pump 540), and one or more condenser water pumps (e.g., condenser water pump 542). In some embodiments, these devices may be identical or substantially similar to devices described above with reference to FIG. 2. For example, cooling tower 508 may be identical or substantially similar to cooling tower subplant 208, chilled water pump 540 may be identical or substantially similar to chilled water pumps 234-236, and condenser water pump 542 may be identical or substantially similar to condenser water pumps 240. In various embodiments, any or all of cooling tower 538, chilled water pump 540, and condenser water pump 542 may be controlled by one or more field controllers (e.g., field controllers 510-514). For example, field controllers 510-514 may be configured to receive control signals from a master controller and transmit control signals to connected devices (e.g., cooling tower 538, chilled water pump 540, and condenser water pump 542). In some embodiments, the connected devices also include isolation valves. As described above with reference to FIG. 2, in various embodiments, isolation valves may be integrated with pumps (e.g., chilled water pump 540, condenser water pump 542) or positioned upstream or downstream of the pumps to control fluid flow.

In various embodiments, chillers 502-508, cooling tower 538, chilled water pump 540, and condenser water pump 542 may be connected over a wireless network 544 via a wired connection to a smart communicating access point (SC-AP) (e.g., SC-AP 516-528). In some embodiments, field controllers 510-514 may communicate with SC-APs 524-528 via a master-subordinate token passing (MSTP) protocol. In some embodiments, the SC-AP is a Mobile Access Portal (MAP) device manufactured by Johnson Controls, Inc. Further details of the MAP device may be found in U.S. patent application Ser. No. 15/261,843 filed Sep. 9, 2016. The entire disclosure of U.S. patent application Ser. No. 15/261,843 is incorporated by reference herein.

Wireless network 544 may enable devices (e.g., chillers 502-508, cooling tower 538, chilled water pump 540, and condenser water pump 542) to communicate with each on a communications bus using any suitable communications protocol (e.g., Wi-Fi, Bluetooth, ZigBee). SC-AP 516-528 may also enable devices to communicate wirelessly via network 530 with connected services 532. In various embodiments, connected services 532 may include a variety of cloud services, remote databases, and remote devices used to configure, control, and view various aspects of CPOS 500. For example, connected services 532 may include a mobile device or a laptop configured to display configuration parameters of CPOS 500 and receive user input regarding the configuration parameters.

In some embodiments, connected services 532 includes configuration database 534. In various embodiments, configuration database 534 may be hosted in a secure web server that permits secure remote access through an internet connection. Configuration database 534 may be configured to store various HVAC device operating parameters that correspond to device identification codes. In some embodiments, configuration database 534 may be queried by a controller via a message containing device identification codes. In response, configuration database 534 may retrieve and transmit device operating parameters to the controller.

Still referring to FIG. 5B, each of the chillers 502-508 is shown to include a display panel 550-556 and a processing circuit 558-564. The display panels 550-556 may be configured to display information to a user regarding the current status of CPOS 500. In some embodiments, display panels 550-556 are also configured to receive user input (e.g., via an attached keypad, touchscreen, etc.). For example, in some embodiments, display panels 550-556 are identical or substantially similar to electronic display 594, described above with reference to FIG. 5A.

Each chiller processing circuit 558-564 may contain a processor 566-572 and memory 574-580. Processors 566-572 can be implemented as general purpose processors, application specific integrated circuits (ASICs), one or more field programmable gate arrays (FPGAs), a group of processing components, or other suitable electronic processing components. Memory 574-580 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 574-580 can be or include volatile memory or non-volatile memory. Memory 574-580 may include object code components, script components, or any other type of information structure for supporting the various activities and information structures described in the present application. According to some embodiments, memory 574-580 is communicably connected to processors 566-572 via processing circuit 558-564 and includes computer code for executing (e.g., by processing circuits 558-564 and/or processors 566-572) one or more processes described herein.

### Central Plant Optimization System Using Artificial Intelligence Models

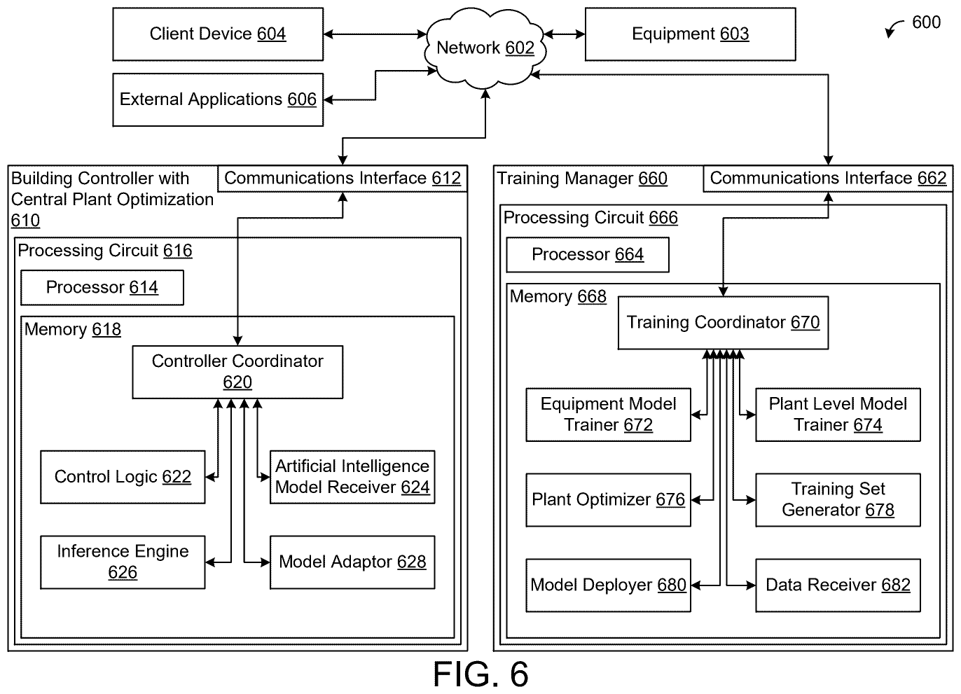

With reference to FIG. 6, system 600 is a system for the optimization of central plant systems according to some embodiments. Optimization of central plant systems may refer to efficiently operating central plant equipment in some embodiments. For example, optimization may refer to generating an optimization problem with a cost function and constraints, determining a solution which minimizes the cost function subject to the constraints using an algorithm, and controlling the equipment based on the solution to the problem. Not all optimization problems can be solved with certainty in a reasonable amount of time; therefore, optimization algorithms may stop looking for better solutions before finding the optimal solution. Using a similar near-optimal solution may also be referred to as optimizing the central plant equipment. In some embodiments, heuristics or partially rule based selection of central plant operating points may use by used to find efficient, optimal, and/or near-optimal operating points for the equipment. Such heuristics or partially rule based selections may also be referred to as optimization. Optimization algorithms may include techniques such as model predictive control, gradient decent, non-linear programming, or mixed integer non-linear programming; simulated biological/physical behaviors including genetic algorithms, particle swarm optimization, simulated annealing, or ant colony optimization.

In some embodiments, system 600 includes equipment 603, client device 604, external applications 606, building controller with central plant optimization 610, training manager 660, and network 602. Network 602 may include multiple networks and network hardware to provide interoperability. For example, network 602 may include communications with BACnet® over IP, BACnet® over MS/TP, TCP/IP, Wi-Fi, Bluetooth, etc. over various media (e.g., twisted pair, wireless, etc.). Client device 604 may be used to access various information from building controller 610 and training manager 660. For example, client device 604 may be configured with proprietary software to provide the display and/or communication of information or building controller and/or training manager 660 may be configured to provide interfaces over standard protocol. For example, a representational state transfer (REST) application programming interface (API) may be used for communication of data and/or commands from and/or to client device 604 and web-based user interfaces may be served to client device 604 using a general-purpose internet browser through a scripting language such as JavaScript. Network 602 also provides communication between building controller 610 and the equipment (e.g., a portion of equipment 603) that it is controlling. In some embodiments, building controller 610 and training manager 660 include a communications interface to provide data to network 602.

In some embodiments, equipment 603 includes heating, ventilation, and air conditioning (HVAC) equipment. In some embodiments, the HVAC equipment includes central plant equipment. Central plant equipment may provide resources (e.g., electricity, water) and/or heat transfer through chilled water, hot water, and/or steam. For example, a central plant may include chillers that chill water for the purpose of rejecting heat from the building. In some embodiments, building controller 610 is configured to provide commands to equipment 603 over network 602. Building controller 610 may also be configured to receive sensor data from equipment 603 over network 602. Using measurements from the sensor data of equipment 603 and sending an appropriate command back to equipment 603 based on the sensor data, building controller 610 may be able to control various operating conditions of the plant (e.g., water temperatures, building zone temperatures, water flows through pipes, etc.)

In some embodiments, system 600 includes external applications 606. External applications may be used to further enhance the user experience. For example, external applications 606 may include a remote operations center that is able to continuously monitor the operations of the building. External applications 606 may provide dashboards for human-in-the-loop monitoring or automatic fault detection. In some embodiments, external applications 606 monitors the operations of building controller with central plant optimization 610 and/or training manager 660. External applications 606 may provide alerts if the commands sent to the central plant equipment exceeds a threshold or is within a calculated region. For example, a region known to provide poor operations. External applications 606 may also monitor the savings provided by performing central plant optimization. In some embodiments, external applications 606 also provide calculations based on information provided by building controller 610 or training manager 660. For example, building controller may be configured to calculate the energy savings, and external applications 606 may be configured to convert energy savings into a cost savings using a utility rate structure or a CO2 savings using the amount of CO2 production based on use of various resources (e.g., electricity or natural gas). Primary, secondary and/or tertiary CO2 production may be calculated if rates are provided.

In some embodiments, building controller 610 and training manager 660 are embodied by separated devices. Building controller 610 may be an edge device. For example, resource limited hardware made for the purpose of performing building control and training manager 660 may be implemented on a node in a cluster of computers (e.g., a cloud implementation). While not limited to embodiments wherein building controller 610 and training manager 660 are implemented separately (e.g., the control and training are separately implemented), such an implementation may provide for efficiency gains by performing less computationally intensive control or inference tasks in resource limited hardware and only using cloud computing when necessary (e.g., for tasks that cannot be performed by building controller 610). Computing costs may be saved by limiting the number of computations done in the cloud. It is noted that the various subsystems shown as configured in building controller 610 or processes shown performed by building controller 610 may, in some embodiments, be configured on or performed on in training manager 660 (e.g., on-site remote system, off-site remote system, or cloud). Similarly, any subsystems configured in training manager 660 or process performed on in training manager 660 may, in some embodiments, be configured on or performed in building controller 610. In some embodiments, any distribution of the subsystems across the building controller 610 and training manager 660 may be used including a distribution that has all instructions stored and executed in the training manager 660 or a distribution that has all instructions stored and executed in building controller 610.

Building controller 610 may contain processor 614, processing circuit 616, and memory 618. Training manager 660 may contain processor 664, processing circuit 666, and memory 668. In some embodiments, other configurations capable of storing and processing instructions may be used. The processors may be a general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.). The processors may be configured in various computer architectures, such as graphics processing units (GPUs), distributed computing architectures, cloud server architectures, client-server architectures, or various combinations thereof. One or more first processors can be implemented by a first device, such as an edge device, and one or more second processors can be implemented by a second device, such as a server or other device that is communicatively coupled with the first device and may have greater processor and/or memory resources. The memories may include one or more devices (e.g., memory units, memory devices, storage devices, etc.) for storing data and/or computer code for completing and/or facilitating the various processes described in the present disclosure. The memories may include random access memory (RAM), read-only memory (ROM), hard drive storage, temporary storage, non-volatile memory, flash memory, optical memory, or any other suitable memory for storing software objects and/or computer instructions. The memories may include database components, object code components, script components, or any other type of information structure for supporting the various activities and information structures described in the present disclosure. The memories may be communicably connected to the processors and can include computer code for executing (e.g., by the processors) one or more processes described herein.

A module described as configured to perform a function (or described as performing the function) may include embodiments for which the module is configured to cause the performance of the function (or is causing the performance of the function). A module described as configured to cause the performance of a function (or described as causing the performance of a function) may include embodiments for which the module is configured to perform the function (or is performing the function).

In some embodiments, building controller with central plant optimization 610 includes a controller coordinator 620. Controller coordinator 620 may be configured to control the timing and flow of data through the other circuitry of building controller 610. For example, controller coordinator 620 may cause the circuits to execute in a specific order to perform the function of building controller 610. In some embodiments, controller coordinator 620 may route the information and/or outputs to other modules that are dependent on the information or use the information as an input.

In some embodiments, building controller 610 includes control logic 622. Control logic 622 may describe the rules and/or sequences of operations used to control a portion of the equipment of the building. For example, control logic 622 may include instructions for performing proportional-integral-derivative (PID) control, operating constraints (e.g., rate limiters, maximum and minimum temperatures, etc.), sequences for turning on equipment, rules for generating setpoints for the PID controllers, etc.

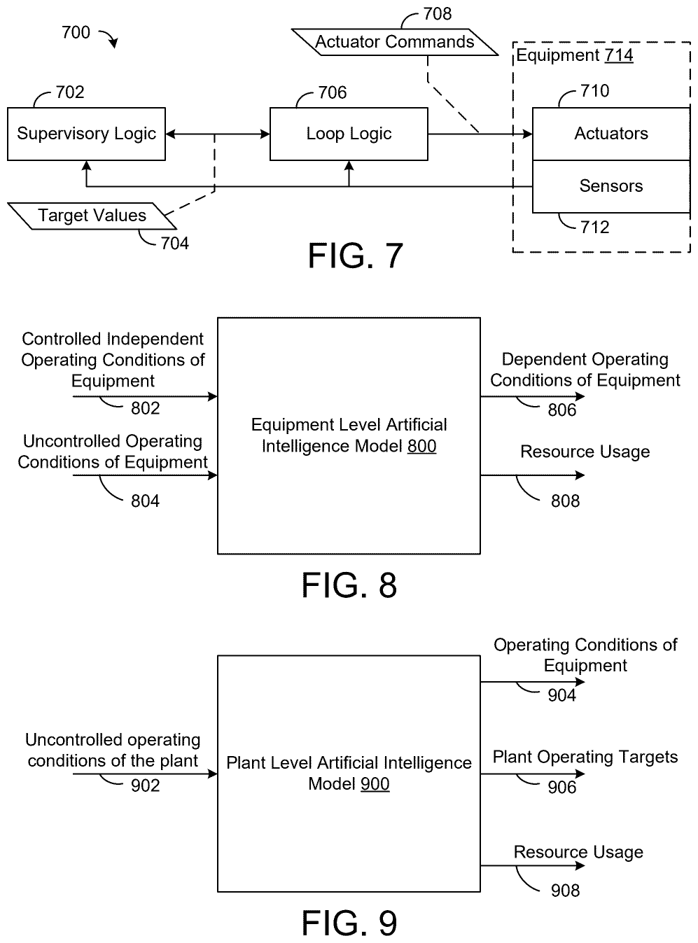

With reference to FIG. 7, automation system 700 may include control logic (e.g., control logic 622). Control logic may include multiple stages. For example, control logic may include supervisory logic 702 and loop logic 706, which together produce the outputs, data, and/or commands that are communicated to actuators 710 of equipment 714. Sensors 712 of equipment 714 may be used to monitor the operations of the equipment and the behavior of the controlled variables of the building so that adjustments to the outputs in response to the current operations. In some embodiments, supervisory logic 702 provides target values 704 (e.g., setpoints) to loop logic 706. Loop logic 706, may provide output to the actuators (e.g., actuator commands 708) to cause the equipment to operate according to target values 704 provided by supervisory logic 702. In some embodiments, loop logic 706 will perform calculations based on measurements from sensors 712 and target values 704 to cause the equipment to converge towards target values 704. However, disturbances and/or model mismatch may prevent the equipment operations from matching the target values 704 precisely.

Referring again to FIG. 6, in some embodiments, building controller 610 includes artificial intelligence model receiver 624. Artificial intelligence model receiver 624 may be configured to receive an artificial intelligence model; for example, from training manager 660. Artificial intelligence model receiver 624 may be configured to receive a model defining, for example, the type of model, the connections between the components of the model, and all the parameters of the model. Or, in some embodiments, a predefined model form may be included within inference engine 626 and artificial intelligence model receiver 624 may only receive the model parameters for inference engine 626. In some embodiments, artificial intelligence model receiver 624 may include validation of the parameters and model architecture provided to building controller 610. For example, artificial intelligence model receiver 624 may be configured to check various parameters against bounds. In some embodiments, artificial intelligence model receiver 624 may cause inference engine 626 to perform inference using the provided model and a set of standard operating conditions. The outputs from inference using these standard operating conditions may be compared against bounds or otherwise used to determine if the outputs are valid (and therefore, the model parameters may be valid).

In some embodiments, inference engine 626 is configured to perform inference. Inference may refer to providing an input to an artificial intelligence model and calculating the output in some embodiments. The output of the inference of a plant-level artificial intelligence model may be communicated to control logic 622, or more specifically the loop logic and may replace any default methods for calculating some setpoints that are not employed when system 600 is operating to improve efficiency of the equipment. In some embodiments, inference engine 626 is configured to use a predefined AI model architecture. In some embodiments, inference engine 626 is configurable and can accept a model form during runtime. The form of the model may be provided automatically, based on the operating conditions, or the model form may be provided by a user (e.g., through client device 604). Inference engine 626 may run periodically (e.g., every 15 minutes), based on an operator request, or inference engine 626 may monitor the inputs to the plant-level AI model and determine when the inputs have changed enough to warrant another execution of the model.

In some embodiments, building controller 610 includes model adaptor 628. Model adaptor 628 may be configured to adapt the parameters of the artificial intelligence model based on the latest operational data. For example, model adaptor 628 may perform a gradient descent iteration every time a number of new operational data samples are obtained. In some embodiments, model adaptor 628 may provide alternative or redundant functionality to training manager 660 or it may replace the functionality of training manager all together. Functionality related to training or otherwise adjusting the parameters of the AI model may be distributed in any way between of training manager 660 and model adaptor 628. In some embodiments, the functionality is split such aspects that can be done in a resource limited environment are performed in model adaptor 628 and computationally intensive functionality is performed in the training manager. For example, a model may be adapted in real-time with a small amount of recent operational data by model adaptor 628 but may be retrained by training manager 660 after a larger amount of training data has been stored.

In some embodiments, system 600 includes training manager 660. Training manager may be configured to train (e.g., determine parameters for) an artificial intelligence model used in central plant optimization. In some embodiments, three general types of training may be performed. High level training may be performed on a large data set using operational data from several central plants and/or several similar equipment. Models obtained from high level training may be saved and used as a starting point for training models to fit the operations of a specific building. Various models can be saved based on criteria used to select the data to train the models. For example, a model may be pre-trained and stored for each vertical market that commonly uses central plants (e.g., higher education, hospitals, manufacturing, etc.). Plant specific training can be performed based on a training data set including operational data for the specific central plant to which the model will be deployed. For example, the training data may include only the plant specific data and use a pre-trained model as a starting point for its parameters or the training data may include both the plant specific data and some data used to train the pre-trained models. For example, data from other buildings may be used or modified and then used to “fill in” operating conditions for which there was no plant specific data. Third, small amounts of recent data may be used to make small adjustments to the existing plant specific model. For example, by performing a single gradient descent step on a batch of the most recent day of plant operations.

Training manager 660 may include training coordinator 670. Training coordinator 670 may be configured to control the timing and flow of data through the other circuitry of training manager 660. For example, training coordinator 670 may cause the circuits to execute in a specific order to perform the function of training manager 660. In some embodiments, training coordinator 670 may route the information and/or outputs of other modules that are dependent on the information or use the information as an input.

In some embodiments, training manager 660 includes equipment model trainer 672. Equipment model trainer 672 may be configured to determine parameters for equipment models. For example, equipment model trainer 672 may include predefined configurations of equipment models for various types of equipment. Based on training data, equipment model trainer 672 may provide parameters that result in good fit between the actual data and the output of the trained equipment-level artificial intelligence model. Several types of equipment models may be available within equipment model trainer 672 (e.g., non-linear regression models, physics-based regression models, multi-layer fully-connected neural networks, convolutional neural networks, etc.). In some embodiments, the user, plant operator, or other person configuring the plant may select the equipment model type that should be used. In some embodiments, the equipment model type is provided based on the equipment type and/or how well a particular model type fits the data after training.

With reference to FIG. 8, equipment-level artificial intelligence (AI) model 800 includes inputs for controlled independent operating conditions of equipment 802 and uncontrolled operating conditions of equipment 804 in some embodiments. Equipment-level AI model 800 may also include outputs for dependent operating conditions of equipment 806 and resource usage 808. Controlled independent operating conditions of equipment 802 refer to a property that may be specified (though possibly subject to a number of constraints) for a given equipment in some embodiments. For example, the condenser water temperature leaving the towers may be a controlled independent operating condition. Uncontrolled operating conditions of equipment 804 refer to a property that may not be specified and is not be affected by other specified operating conditions in some embodiments. For example, uncontrolled operating conditions of equipment may refer to the outdoor air temperature, outdoor air wet-bulb temperature, or the amount of heat the equipment of the central plant must reject. Dependent operating conditions of the equipment 806 refer to operating conditions that may or may not be controlled but depend on the controlled independent and uncontrolled operating conditions of the equipment in some embodiments. For example, dependent operating conditions of the equipment 806 may refer to the heat moved onto the condenser loop by the chiller. Dependent operating conditions of the equipment 806 and resource usage 808 both depend on controlled independent operating conditions of equipment 802 and uncontrolled operating conditions of equipment 804. In some embodiments, resource usage 808 is an electrical power consumed by the devices. In some embodiments, resource usage 808 in not limited to one type of resource usage and may include resource usages that are not measured in units of power (e.g., water usage may be measured in gallons per hour or natural gas usage may be measured in cubic feet per hour). Additionally, resource usage 808 may include other adverse effects of operating the equipment that are not resource usages. For example, the production of CO2 may be an output of equipment-level artificial intelligence model 800 or the wear of any components of the equipment may also be output. The inputs and outputs for two example equipment-level artificial intelligence models are shown below.
Equipment: Chiller
Controlled Independent Operating Conditions of the Equipment:
   Entering condenser water temperature
   Exiting chilled water temperature
   Heat rejection load
Uncontrolled Operating Conditions of the equipment: None
Dependent Operating Conditions of the equipment:
   Heat added to condenser loop
Resource Usage:
   Electricity usage
Equipment: Cooling Tower
Controlled Independent Operating Conditions of the equipment:
   Exiting condenser water temperature
Uncontrolled Operating Conditions of the equipment:
   Wet-bulb temperature
Dependent Operating Conditions of the equipment:
   Fan speed
Resource Usage:
   Electricity usage
   Water usage

In some embodiments, plant-level model trainer 674, is configured to train plant-level AI models using the equipment-level AI models. With reference to FIG. 9, a plant-level AI model (e.g., model 900) accepts uncontrolled operating conditions of the plant 902 as input and outputs operation conditions of equipment 904, plant operating targets 906, and resource usage 908 in some embodiments. Uncontrolled operation conditions of the plant 902 refers to the conditions over which building controller does not have direct control over in some embodiments. For example, the uncontrolled operating conditions of the plant may include weather and/or building heat rejection or heating loads. Operating conditions of the equipment 904 may refer to any operating conditions of the equipment (e.g., controlled or uncontrolled, dependent or independent) that are not plant operating targets. The operating conditions of the equipment that are output by plant-level AI model may not be required by the loop logic. Therefore, a subset of dependent operating conditions that are useful for display may be calculated. Plant operating targets refer to the set of controlled independent operating conditions of the equipment 802 and dependent operating conditions of the equipment 806 across all equipment in the central plant that are required setpoints and not in another way determined by supervisory logic in some embodiments. For example, plant operating targets may refer to all operating conditions of the plant that can be independently controlled. In some embodiments, controlled independent operating conditions of the equipment may be provided by supervisory logic external to the plant-level AI model. Such controlled independent operating conditions of the equipment may be considered uncontrolled operating conditions of the plant (e.g., as part of input 902 rather than part of plant operating targets 906) because these operating conditions are not controlled by the plant-level AI model. For example, plant operating targets may include chiller condenser water entering temperature (in many control systems it is a setpoint that controls cooling tower fan speed and/or condenser water pump speed) but chiller evaporator exiting water temperature (a value used to control chiller operations in many control systems) may be provided by supervisory logic (e.g., provided as an operator input or based on a schedule).

Resource usage 908 includes resource usages and/or any adverse effect of running the central plant in some embodiments. Additionally, resource usage 908 may include resource usages and/or effects that are not measured in units of power (e.g., in addition to electrical power). For example, resource usage 908 may be similarly defined as resource usage 808, but at the level of the central plant rather than individual equipment or sets thereof.

In some embodiments, plant-level model trainer 674 is configured to generate training data. Plant-level model trainer 674 may be configured to create an optimization problem using the equipment-level artificial intelligence models. Plant-level model trainer 674 may, for example, determine an appropriate cost function. In some embodiments the cost function is a monetary cost and in some embodiments the cost function is a non-monetary cost. For example, a cost function may include the electrical usage of all equipment in the central plant as estimated by equipment-level AI models,

where

$$J = {\sum }_{i = 1}^{N} ,$$

where [symbol] is the estimated electrical use of the i^{th} equipment; or a cost function may include the cost of multiple resource usages,

$$J = {\sum }_{i = 1}^{N} {r}_{e} + {r}_{n} ,$$

where nᵢ is the estimated natural gas use of the i^{th} equipment and rₑ and rₙ, are the electrical and natural gas rates, respectively. In some embodiments, the rates may be the actual monetary cost per unit of the resource used. However, other rates can be used. For example, a rate may be a “blended” rate that uses a weighted average of different rates; for example, if the true monetary cost of the resource is tiered or subject to block-and-index pricing. In some embodiments, penalties may be added to the rate to favor the usage of one resource. For example, to favor electrical consumption and avoid burning non-renewable resources.

Calculation of the cost function may require a series of calculations traversing the central plant equipment using the equipment-level AI models, the uncontrolled operating conditions of the plant, and tentative plant operating targets to calculate dependent operating conditions of the equipment that can be used as or to determine controlled independent operating conditions of other equipment. Tentative plant operating targets refer to the values used during a particular iteration of the optimization algorithm in some embodiments.

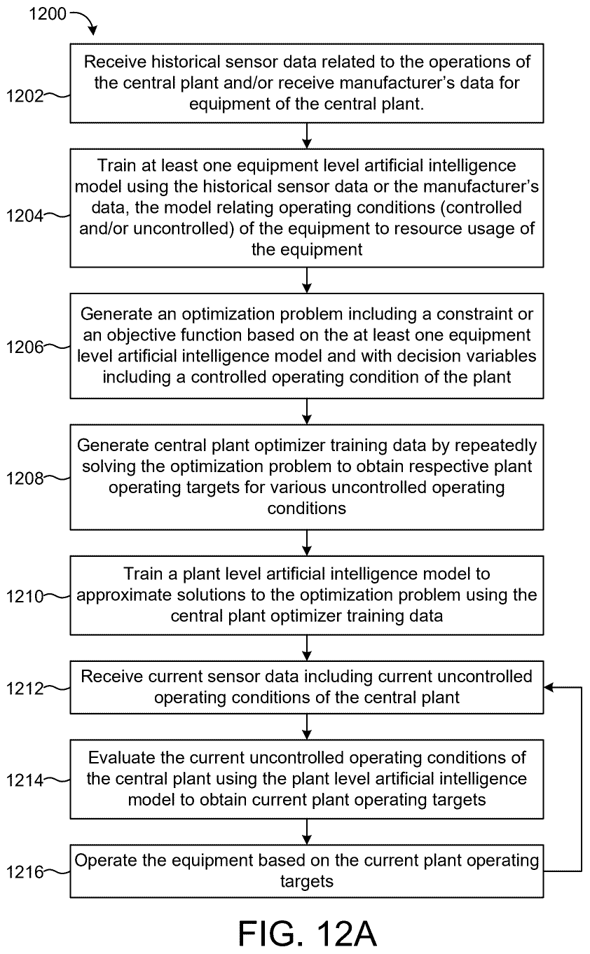

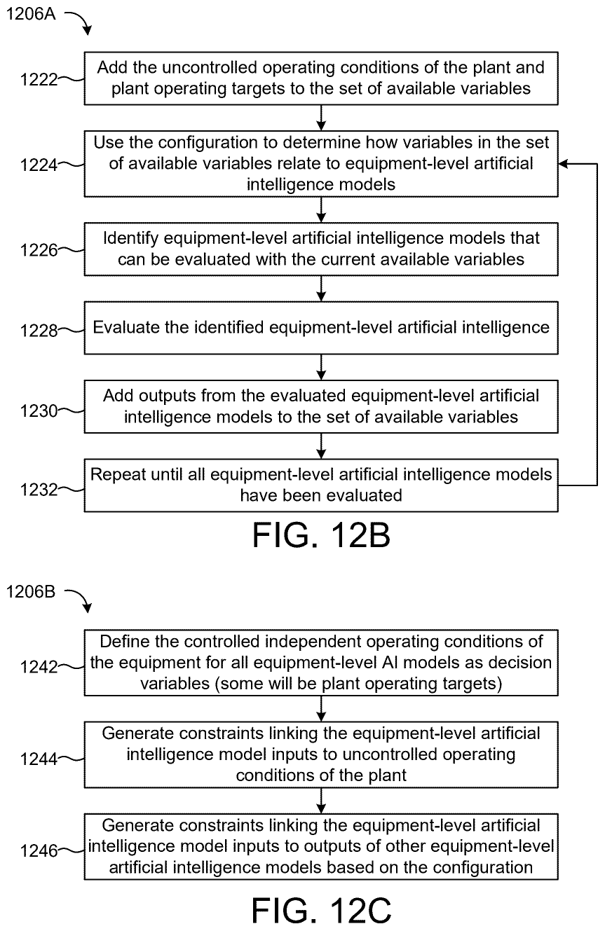

In some embodiments, plant-level model trainer 674 may be configured to determine the decision variables for the optimization problem. Decision variables may include the variables that the plant-level AI model outputs (e.g., the plant operating targets 906). It is noted that the strategy used to define the optimization problem may determine the number of decision variables. For example, the exiting water temperature of cooling towers is (in many central plants) equal to the condenser water entering temperature of the chillers (neglecting a small amount of heat exchange as the water travels through the pipes). The optimization problem may be created either by generating a decision variable for each of these temperatures and linking them with an equality constraint, or by generating a single decision variable and linking them within the evaluation of the cost function. The operations for defining an optimization problem will be described in more detail below with reference to FIGS. 12B and 12C.

In some embodiments, plant-level model trainer 674 may be configured to determine constraints for the optimization problem. Constraints may include upper and lower bounds of the decision variables; constraints that relate multiple decision variables (e.g., condenser water temperature leaving the towers must be less than condenser water temperature leaving the chillers); and/or equality constraints that are generated based on the interconnections of equipment (e.g., the plant configuration).

In some embodiments, training manager 660 includes plant optimizer 676. Plant optimizer 676 may be configured to perform optimization of the cost function. Plant optimizer 676, for example, may determine the set of equipment to turn on and the setpoints of the equipment that results in a low value of the cost function. Optimization algorithms may include model predictive control, gradient decent, non-linear programming, mixed integer non-linear programming; or simulated biological/physical behaviors including genetic algorithms, particle swarm optimization, simulated annealing, or ant colony optimization.

In some embodiments, training manager 660 includes training set generator 678. Training set generator 678 may be configured to generate training data by providing example uncontrolled operating conditions of the plant to plant optimizer 676. The data used by training set generator 678 may include historical data. For example, the previous year of operating conditions could be used. In some embodiments, training set generator 678 may generate uncontrolled operating conditions of the plant specifically to generate training data within a region of the possible operating conditions. Generated input data to plant optimizer 676 could be used with or without historical data. For example, training set generator 678 may generate input data that is on a grid within the multi-dimensional space of the uncontrolled operating conditions of the plant or training set generator 678 may provide data in regions of the multi-dimensional space that do not often occur in historical data (e.g., low required building heat rejection, but high temperature), but would be helpful for training to prevent poor extrapolations by the plant-level AI model. Training set generator may be configured to provide the input data to plant optimizer 676 and save the results for supervised training of the plant-level AI model.

In some embodiments, plant-level model trainer 674 may be configured to determine parameters for the plant-level AI model using the training data stored by training set generator 678. For example, the plant-level AI model may be trained to approximate the outputs of plant optimizer 676 (e.g., dependent operating conditions of the equipment, plant operating targets, and resource usage) for the same input using stochastic gradient descent.

In some embodiments, model deployer 680 is configured to communicate the parameters of the plant-level AI model or the model itself to building controller 610. This deployment may be performed at the request of a plant operator, when enough data has been obtained, or based on an update schedule.

In some embodiments, training manager 660 includes data receiver 682. Data receiver 682 may be configured to receive and store historical operational data. The historical data may be used to develop an initial set of the plant or equipment-level AI models or to adjust those parameters as equipment performance and/or operations change.

In some embodiments, the AI models are used to provide estimates of the savings realized by operating the equipment according to calculated plant operating targets. For example, building controller 610 may have control logic 622 that includes default methods (e.g., rule-based, etc.) for calculating plant operating targets when the AI-based optimization is not being performed or the results from the plant-level AI model are not being used. Those same default methods could be used to determine the default plant operating targets when AI-based optimization is being performed. The optimization objective function may include procedures for estimating the operating cost (or energy usage, etc.) when operating according to any plant operating targets. Both the optimal plant operating targets and the default plant operating targets may be provided to the optimization objective function in order to calculate a cost for both scenarios. In some embodiments, the difference between the costs of the two scenarios is the estimated savings realized by operating according to the optimized plant targets. The estimated savings may be integrated with respect to time to calculate savings over a longer period of time.

In some embodiments, building controller 610 offers an automatic and an advisory mode of operations. In automatic mode, the equipment may be operated in accordance with the plant operating targets from the AI model without human intervention. In advisory mode, a human may have to accept the plant operating targets before they are used as setpoints by the loop logic. In some embodiments, while operating in advisory mode, the building controller may integrate “savings lost” by performing the comparison described above to calculate realized savings. Savings lost may be provided to the operator to indicate how much savings is being lost by not operating in automatic mode. Savings lost may also be integrated with a measurement and verification module. For example, to provide reasons as to why a savings guarantee was not met.

In some embodiments, the functionality required to perform the savings calculation or any derived calculation from the savings is distributed across, building controller 610, training manager 660, and external applications 606 or any combination thereof.

In some embodiments, the plant-level AI model may include the ability to perform the savings calculation. For example, the procedure for calculating cost from plant operating targets may be embedded in an additional portion of plant-level AI model. In some embodiments, the training data includes the estimated savings and the plant-level AI model is trained to output the estimated savings using the training data.

### Central Plant Optimization Strategies Using Artificial Intelligence Models

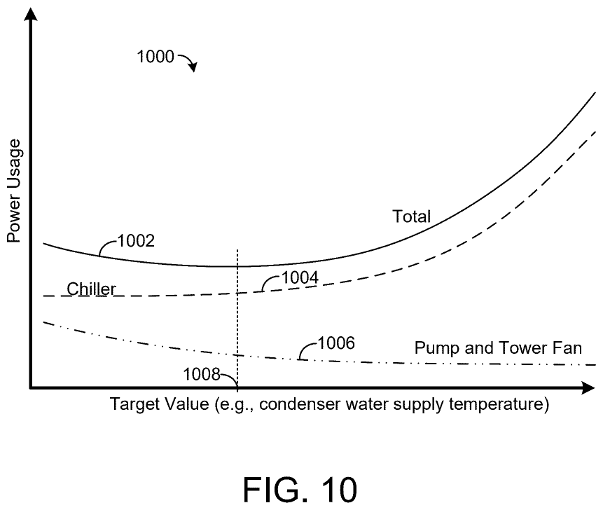

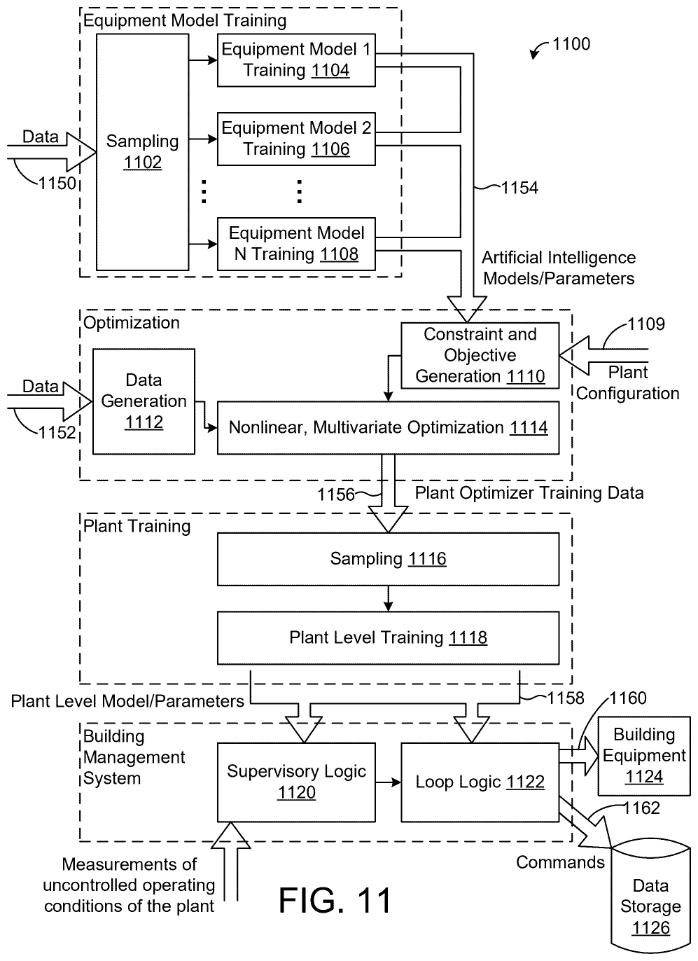

FIGS. 10 and 11 describe the general strategy for using artificial intelligence models to perform central plant optimization. With reference to FIG. 10, for many target operating conditions (e.g., a setpoint) raising the value may cause efficiency gains in one equipment, while causing an efficiency degradation in another equipment. Advantageously, an optimization system may be able to determine values at which the degradation of efficiency of one equipment outweighs the efficiency gains of the other and thus find values for which resource usage (e.g., electrical power usage) is near its minimum.

Plot 1000 shows power usage for various equipment as a function of a target value according to some embodiments. Curve 1002 indicates how the total power usage of a chiller, tower, and respective pumps change as a function of the target value (e.g., the condenser water supply temperature to the chiller). Curve 1004 is the power usage of just the chiller, while curve 1006 is the power usage of the pumps and cooling tower fan. At low condenser water temperatures, the chiller power usage may not increase much as the condenser water supply temperature is increased. The chiller control, for example, may not be able to take advantage of the lower temperatures. As the condenser water supply temperature increases, the pump and tower fan power may decrease. For example, less air flow may be required in the tower to cool the condenser water to increased temperature or less water flow may be required through the condenser of the chiller to collect the heat that is moved out of the chilled water loop. In either of these examples, the speed of a motor (either driving the fan or driving the pump) may be reduced and energy saved. However, as condenser water temperatures increases, the chiller's compressor may have to work against higher refrigerant pressures to move the heat and the chiller power usage will start to increase. At value 1008 the marginal decrease in the pump and tower fan power usage matches the marginal increase in the chiller power and the total power usage is at its minimum.

The value for which the power usage is at a minimum may change based on several operating conditions of the plant. For example, wet-bulb temperature will affect the tower fan power used in cooling the condenser water and the total amount heat that the chiller must remove from the chilled water may affect its efficiency. Performing the optimization may be computationally intensive and/or difficult to run on resource limited edge controllers. Training an artificial intelligence (AI) model to approximate the results of the optimization problem may allow for near-optimal target values to be found by evaluating the AI model rather than performing the computationally expensive optimization. Computational savings may allow for (i) calculation of target values to be performed in the resource limited environment of a building controller avoiding cloud computation costs, (ii) calculation of target values to be performed in the resource limited environment of a building controller avoiding communications issues between the optimizer and the building controller, and (iii) calculation of target values to be performed more frequently thus responding faster to any changes in the uncontrolled variables that may affect the optimal target values.

Referring now to FIG. 11, signal flow diagram 1100 shows how information flows within a system for central plant optimization using artificial intelligence models. Operations begin with data 1150 that may include historical operations of the central plant, manufacturers data for the equipment of the central plant and/or any combination of the two. In some embodiments, data is sampled in block 1102 (e.g., by equipment model trainer 672). Sampling may include choosing the required variables to train an AI model for a specific equipment. Sampling may also include choosing samples from the data. For example, sampling may be performed by choosing a sample of the variables each hour. In some embodiments, sampling includes choosing data based on what region of the multi-dimensional space of inputs to the AI model the data exists in. A higher percentage of data from operating regions that are infrequent may be sampled so that the AI model is trained with representative data from all regions of the input space.

In some embodiments, the sampled data is provided to equipment specific model training modules (e.g., blocks 1104, 1106, and 1108). Training may be performed on a single piece of equipment (e.g., a chiller), groups of similar equipment (e.g., a group of three headered pumps), and/or subsystems of multiple types of equipment (e.g., a group of three towers and the three pumps serving the towers). In some embodiments, training is performed by training manager 660 (e.g., by equipment model trainer 672).

In some embodiments, the type of model used depends on the equipment being modeled. For example, a chiller may use a parameterized non-linear function (e.g., a biquadratic function), the towers may be modeled with a fully-connected neural network, and the pumps may be modeled by a multi-layer perceptron network. Any model can be used (e.g., non-linear regression models, physics-based regression models, multi-layer fully-connected neural networks, convolutional neural networks, etc.). In some embodiments, the training methodology used to train a network depends on the model type. For example, non-linear regression models may use least squares or some other similar cost function for parameter fitting and a multi-layer perceptron network may use stochastic gradient descent with backpropagation to perform the training.

AI model parameters and/or the models may be output from the equipment model training and communicated to optimization by information flow 1154. The equipment-level AI models are combined with the plant configuration 1109 to create the optimization problem including constraints and objective function in block 1110 (e.g., the combinations may be performed by plant-level model trainer 674). In some embodiments, equipment models are combined using constraints relating the various inputs and outputs of the equipment-level models. These relations may arise from the configuration of the plant equipment (e.g., the interconnection of devices). To determine the resource usages from all the equipment models it may be necessary to provide all the inputs to each of the equipment models. In some embodiments, not all the controlled independent operating conditions of the equipment can be provided independent targets for control (and thus be used as independent decision variables for optimization). The configuration of the equipment may cause several constraints on what can be controlled independently. For example, if chillers are headered on the condenser side all must have the same condenser water input temperatures. The configuration of the control system may also cause several constraints on what can be controlled independently. For example, the configuration of equipment may not preclude the chillers from each operating at a different chilled water output temperature. However, the control system may only accept a single input setpoint that is distributed to all the chillers.

In some embodiments, during calculation of the objective function the plant block 1110 may determine a set of decision variables based on plant configuration 1109. Then, using constraints provided by plant configuration 1109 and equipment-level AI models traverse the models sequentially calculate the outputs of a model for which all inputs are available, provide those outputs to models which use them as inputs based on the configuration, and evaluate the models for which the inputs are now all available in view of the outputs that were just calculated. In some embodiments, decision variables include, a set of the controlled independent operating conditions of the equipment and which equipment is to be operated.

In some embodiments, all controlled independent inputs to the equipment-level AI models are decision variables and constraints are provided to the optimizer rather than embedding the constraints in the calculation of the objective function. In some embodiments, the output of block 1110 is a procedure for calculating the objective function (e.g., computer instructions) and constraints. The operations for generating an optimization problem are described in more detail below, with reference to FIGS. 12B and 12C.

In some embodiments, block 1112 provides data in the form of uncontrolled operating conditions of the plant for which optimization of plant operating conditions is to be performed (e.g., the functionality may be performed by training set generator 678). A strategy of signal flow diagram 1100 may be to determine an AI model capable of replacing the optimizer. Thus, it may be advantageous to provide data to the optimizer that span all expected operating conditions that the plant could experience when generating training data. Block 1112 may receive data 1152. Data 1152 may be the same as data 1150 or may include different historical data. Data 1152 may also provide manufacturer's data to provide the operating ranges of the equipment that are acceptable. In some embodiments, data generation of block 1112 is performed by selecting a year of the uncontrolled operating conditions of the plant. In some embodiments, data generation of block 1112 is performed by producing a regular (e.g., grid-based) sampling within the multi-dimensional space of uncontrolled operating conditions of the plant.

In some embodiments, block 1114 receives an operating condition of the plant, proposes plant operating targets, and uses the objective function and/or constraints to calculate the objective (e.g., cost) given the proposed plant operating targets. The process of proposing plant operating targets and calculating the objective given these targets may be repeated until plant operating targets that provide a suitable objective value are found. In some embodiments, a nonlinear, multivariate optimization is performed in block 1114 (e.g., these features may be performed by plant optimizer 676 or a similar module). Optimization may be performed by model predictive control, gradient decent, non-linear programming, mixed integer non-linear programming or simulated biological/physical behaviors including genetic algorithms, particle swarm optimization, simulated annealing, or ant colony optimization.

In some embodiments, the uncontrolled operating conditions of the plant are saved with the respective plant operating targets found using the optimization procedure. The data may be provided in information flow 1156 and used as plant optimizer training data. In some embodiments, the value of the objective function, estimated savings, and/or other controlled operating conditions of the equipment are stored and also used in training of the AI model.

Plant optimizer training data may be used to train a plant-level AI model (e.g., processed by plant-level model trainer 674). With reference to FIG. 9, the plant-level AI model may accept uncontrolled operating conditions of the plant (e.g., wet-bulb, air temperature, required heat rejection from the building, etc.) as input and calculate operating conditions of the equipment (e.g., condenser water flow), plant operating targets (e.g., condenser water temperature entering the chillers, which chillers to run, etc.), and resource usage (e.g, electrical power usage, CO2 production, etc.). In some embodiments, block 1116 performs sampling on the training data. For example, some operating conditions of the equipment may not be displayed or sent to the building controller for control and thus not need to be calculated. These outputs may be removed by block 1116 so computations are not spent training the model to predict such outputs or spent calculating them in the building controller.

In some embodiments, the remaining data of plant optimizer training data is provided to block 1118 to train the plant-level AI model. Training may be performed by adjusting parameters such that outputs for a given set of uncontrolled operational conditions of the plant match those outputs determined by the optimizer for the same inputs. In some embodiments, the training methodology used to train a network depends on the model type. For example, a multi-layer perceptron may use a backpropagation algorithm to perform the training. In some embodiments, the plant-level AI model may be a combination of models trained to approximate different outputs. For example, a separate multi-layer fully-connected neural network may be used to approximate each plant operating target.

In some embodiments, the plant-level model or its parameters are communicated to the building management system (e.g., to building controller 610) in information flow 1158. In some embodiments, the procedure for calculating the objective function may also be provided to the building controller. This procedure is run multiple times during optimization (e.g., to approximate gradients, etc.), but may be used to calculate the operating conditions of the equipment and resource usage given the plant operating targets. Providing this procedure for directly calculating the values other than the plant operating targets may provide for fewer parameters within the plant-level artificial intelligence model and ultimately reduce computational intensity compared to requiring the plant-level artificial intelligence model to calculate all outputs.

In some embodiments, the plant-level AI model or its parameters are provided to block 1120, block 1122, or both. The functionality of block 1120 and 1122 may be performed by control logic 622 (e.g., those portions of the control logic not using the plant-level AI model) and/or inference engine 628 (e.g., for calculation of plant operating targets using the plant level AI model). Measurements of the uncontrolled operating conditions of the plant may be received by the building management system and provided as input to the plant-level AI model. The plant-level AI may provide the plant operating targets to block 1122 for control and/or to storage for display or later calculations of savings potential. To operating the equipment in accordance to the plant operational targets, loop logic of block 1122 may use measurements to convert the targets into commands, etc. for building equipment 1124 and/or data storage 1126. In some embodiments, building equipment 1124 is configured to control the equipment according to the plant operational targets.

### Operational Flow

FIGS. 12-14 illustrate flows of operations that are used to execute the central plant optimization strategies according to some embodiments.

FIG. 12 illustrates flow of operations 1200 that may be used to perform central plant optimization using artificial intelligence (AI) models in some embodiments. Flow 1200 includes both training the model and operating the equipment based on inference from the AI models according to some embodiments.

In some embodiments, flow 1200 includes receiving historical sensor data related to the operations of the central plant in operation 1202. Historical sensor information may include data from a recent time period for which data was collected. For example, the last 12 months of data or the last 6 months of data. A trade-off may be made between the amount of data and how recent the data is. For example, including more data can lead to more accurate models; however, may reflect operations that are not recent. It may also be advantageous to include data from all weather patterns experienced at the location of the central plant. This may require 12 months of data if all seasons are different.

In some embodiments, flow 1200 includes receiving manufacturer's data describing expected equipment behavior for equipment used in the central plant in operation 1202. For example, manufacturer's data may include the efficiency of a chiller at various operating conditions (e.g., condenser and evaporator leaving temperatures, and heat rejection load).

In some embodiments, flow 1200 includes training at least one equipment-level AI model using the historical sensor data or the manufacturer's data in operation 1204. The equipment-level AI model may relate controlled and/or uncontrolled operating conditions of the equipment to energy usage of the equipment. For example, as indicated in FIG. 8. Several types of equipment models may be available (e.g., those stored within equipment model trainer 672 including but not limited to: non-linear regression models, physics-based regression models, multi-layer fully-connected neural networks, convolutional neural networks, etc.). In some embodiments, the user, plant operator, or other person configuring the plant may select the equipment model type that should be used. In some embodiments, the equipment model type is provided based on the equipment type and/or how well a particular model type fits the data after training.

Training of equipment-level AI models may be based on the type of AI model used. For example, physics-based regression models may use a least squares optimization method and multi-layer perceptron neural networks may use a backpropagation method.

In some embodiments, flow 1200 includes generating an optimization problem including a constraint or objective function based on the at least one equipment-level AI model and decision variables including a plant operating target (e.g., an operating condition of the plant that can be independently controlled) in operation in operation 1206. This operation has been described with reference to block 1110 of FIG. 11. Operating 1206 may be implemented in at least two distinct flows of operations. The details of these flows, according to some embodiments, are presented in flow 1206A of FIGS. 12B and 1206B of FIG. 12C.

Flow 1206A may represent operations for evaluating an objective function where the constraints based on the configuration are embedded into the calculation of the objective function. The operations described herein may be included as part of the objective function of the optimization problem that is generated. In some embodiments, flow 1206A includes adding the uncontrolled operating conditions of the plant and the plant operating targets to the set of available variables in operation 1222. As will be made clear through consideration of FIG. 12B, in some embodiments, the evaluation of the cost function relies on maintaining a set of variables that are known, evaluating the models that can be evaluated, and adding the outputs to the set of known variables. In operation 1222, the initial known values of the uncontrolled operating conditions (e.g., weather) and the (proposed) plant operating targets may be added to the set.

In some embodiments, flow 1206A includes using the configuration of the plant (e.g., interconnections between equipment to determine how variables in the set of known variables relate to the inputs of the equipment-level AI models in step 1224. For example, this operation may map the wet-bulb temperature to all model inputs that use wet-bulb temperature, or this operation may map the weighted average of the temperatures of all flows into a pipe to all model inputs that are connected to the output of the pipe. In some embodiments, flow 1206A includes identifying the equipment-level AI models that can be evaluated with the current known variables in operation 1226. For example, the models for which all the inputs are known (or mapped to) may be evaluated.

In some embodiments, flow 1206A includes evaluating the identified equipment-level artificial intelligence models in operation 1228. The evaluations may produce outputs that are can be mapped to more inputs. Flow 1206A may include adding the outputs of the evaluated equipment-level AI models to the set of known variables in operation 1230. Flow 1206A may include repeating these operations until all of the equipment-level AI models have been evaluated and their power usage or other function of resource usage can be added across the models (as indicated in operation 1232).

Flow 1206B may represent operations for evaluating the objective function where all the controlled independent operating conditions of the equipment are defined as decision variables and the constraints linking the controlled independent operating conditions of the equipment are managed by the optimization routine. In some embodiments, flow 1206B includes defining the controlled independent operating conditions of the equipment for all equipment-level AI models as decision variables in operation 1242. Flow 1206B may include generating constraints linking the equipment-level AI model inputs to uncontrolled operating conditions of the plant in operation 1244. With these two considerations it may be possible to evaluate all the equipment-level AI models for any proposed set of decision values. The objective function may be the sum of the power usage outputs for all models in some embodiments. In some embodiments, the objective function may be the sum of various resource usages multiplied by their respective rates (e.g., cost per unit). Flow 1206B may include operation 1246 in which constraints are generated that link the equipment-level AI model inputs to outputs of other equipment-level AI models based on the plant configuration. Flow 1206B may rely on the optimization routine to generate solutions that satisfy all the constraints and thus would be consistent with the physics represented by the constraints from the configuration.

Referring again to FIG. 12A flow 1200 may continue with operation 1208 after the objective function and/or constraints have been generated. In operation 1208 the optimization problem including the constraints and/or objective function from operation 1206 is solved a number of times. The optimization problem may be solved using any optimization technique. For example, gradient decent, non-linear programming, or mixed integer non-linear programming; simulated biological/physical behaviors including genetic algorithms, particle swarm optimization, simulated annealing, or ant colony optimization may be used. The optimization routine may be responsible for generating proposed sets of decision variables including the plant operating targets and iteratively trying to find decision variables that minimize the objective function while satisfying the constraints. The solutions (or best set of decision variables found) to the optimization problem for various uncontrolled operating conditions of the plant may be stored for central plant optimizer training data.

In some embodiments, flow 1200 includes using the central plant optimizer training data to train a plant-level AI model to approximate solutions to the optimization problem in operation 1210. Because the central plant optimizer training data includes both the inputs and the outputs to the plant-level AI model, supervised training may be used to adjust the parameters of the plant-level AI model such that error between the optimizer results and the model output is low across the training set.

In some embodiments, after the plant-level AI model has been trained it can be used live to perform central plant optimization. This for example, may include deploying the model in an edge device such as a building controller if the training is performed on a server class machine or in the cloud.

In some embodiments, flow 1200 includes receiving current sensor data including the current uncontrolled operating conditions of the central plant in operation 1212. The uncontrolled operating conditions may include weather, building heat rejection requirements, and/or other setpoints that are not optimized but rather controlled by other control logic. In some embodiments, the data may include predictions of the sensor data (e.g., outside air conditions) and use the predictions in later operations of flow 1200. This could be used to display to the user the expected operations of the equipment in the future. In some embodiments, flow 1200 includes evaluating the current uncontrolled operating conditions of the plan using the plant-level AI model to obtain current plant operating targets in operation 1214. In some embodiments, flow 1200 includes operating the equipment according to the current plant operating targets in step 1216. Operating the equipment in accordance (or based on) plant operating targets may refer to providing the targets to the loop-level control logic as setpoints. This does not guarantee that the equipment will operate at the target exactly but, assuming the control logic is proper, may cause the equipment to converge toward the operating targets and or maintain approximately the target value in the presence of disturbances.

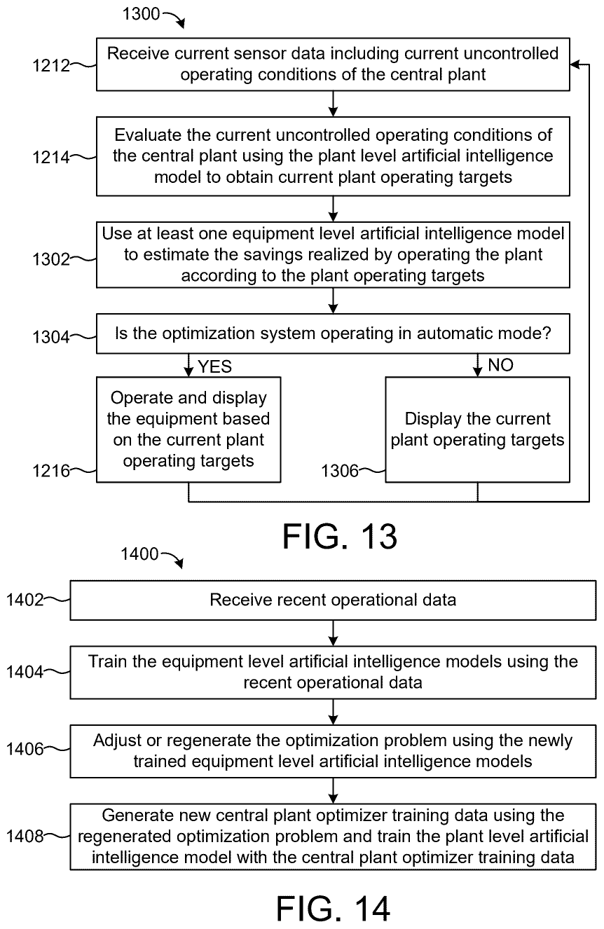

FIG. 13 shows flow of operations 1300 that can be used to provide an advisory and automatic mode of central plant operations according to some embodiments. Flow 1300 represents some embodiments of active optimization portion of the present disclosure (e.g., after training has been performed). In some embodiments, flow 1300 includes receiving current uncontrolled operating conditions of the plant and evaluating those conditions using the plant-level AI model to obtain current plant operating targets in operations 1212 and 1214. In some embodiments, flow 1300 includes using at least one equipment-level AI model to estimate the savings realized by operating the plant according to the plant operating targets (or estimate the savings lost by not operating according to the plant operating targets) in operation 1302. For example, default methods (e.g., rule-based, etc.) for calculating plant operating targets when the AI-based optimization is not being performed or the results are not being used may be used to determine inputs to a cost calculation even when optimization is being performed. Both the optimal plant operating targets and the default plant operating targets may be provided to the optimization objective function in order to calculate a cost for both scenarios. In some embodiments, the difference between the costs of the two scenarios is the estimated savings realized by operating according to the optimized plant targets.

In some embodiments, flow 1300 includes decision operation 1304 which determines if the optimization system is in automatic mode. When the optimization system is in automatic mode flow 1300 may continue with operation 1216 and operate the equipment according to the plant operating targets. In some embodiments, the savings being realized is displayed for the operator when in automatic mode. When the optimization system is not in automatic mode flow 1330 may continue with operation 1306 and display the current plant operating targets. In some embodiments, the savings lost by not operating in automatic model is displayed if the system is not in automatic mode.

Periodically, it may be advantageous to update the models (the plant-level and/or the equipment-level AI models may be updated). Periodically updating the models will cause the models to represent more recent operations of the equipment and/or plant and may determine operating targets that provide more efficient operations. FIG. 14 shows flow of operations 1400 for updating and/or adjusting the parameters of the AI models according to some embodiments. In some embodiments, flow 1400 includes receiving recent operational data in operation 1402. The recent operational data may be any amount of recent past operations. For example, the last month of operations, the last 3 months of operation, or training could be done continuously as each new data point is received.

In some embodiments, flow 1400 includes training the equipment-level AI models using the recent operational data in operation 1404. The recent operational data may be used to augment the historical data used to train the original models or training could be performed solely on the recent operational data. Some methods of adjusting model parameters are designed such that the historical data does not have to be stored and instead small adjustments may be made as each new sample is received. For example, training neural networks using gradient descent may rely on a small batch of samples and not require storage of a large history or models trained using least squares can be formulated in a recursive least squares fashion. In some embodiments, a building controller (e.g., building controller 610) may perform adjustments of the parameters using a small amount of recent operational data before discarding the data. The same data may be stored in a central location (e.g., training manager 660) and used to perform full retraining of the equipment-level AI models, potentially on a less frequent basis.

In some embodiments, flow 1400 includes regenerating the optimization problem using the newly trained equipment-level AI models in operation 1406 and in operation 1408 generating new training data using the regenerated optimization problem and training the plant-level artificial intelligence model with new training data. The plant-level AI model generated in flow 1400 may be used in operating the equipment. For example, according to operations 1212-1216 or flow 1300.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The construction and arrangement of the systems and methods as shown in the various exemplary embodiments are illustrative only. Although only a few embodiments have been described in detail in this disclosure, many modifications are possible. For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (i.e., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can include RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method for improving efficiency of a central plant, the method comprising:
generating an optimization problem, wherein the optimization problem comprises a constraint based on at least one equipment-level artificial intelligence model or an objective function based on the at least one equipment-level artificial intelligence model;
solving the optimization problem to obtain central plant optimizer training data;
training a plant-level artificial intelligence model to approximate solutions to the optimization problem using the central plant optimizer training data; and
operating equipment of the central plant based on current plant operating targets generated by evaluating the plant-level artificial intelligence model.

2. The method of claim 1, wherein the at least one equipment-level artificial intelligence model relates controlled operating conditions of equipment to energy usage of the equipment, wherein decision variables of the optimization problem comprise at least one of the controlled operating conditions of the equipment.

3. The method of claim 1, further comprising providing uncontrolled operating conditions of the central plant, wherein solving the optimization problem comprises at least one of (i) using the uncontrolled operating conditions of the central plant to generate a second constraint or (ii) basing the objective function on the uncontrolled operating conditions of the central plant, and wherein the central plant optimizer training data comprises respective plant operating targets for the uncontrolled operating conditions of the central plant.

4. The method of claim 3, wherein the current plant operating targets comprise at least one of:
a target condenser water flow through a chiller;
a target exiting condenser water temperature for the chiller;
a target exiting condenser water temperature for a cooling tower;
a target exiting evaporator water temperature for the chiller;
a target speed for a condenser water pump; or
a target speed for a cooling tower fan.

5. The method of claim 3, wherein the uncontrolled operating conditions of the central plant comprise at least one of:
a required production of the central plant;
an outdoor air temperature; or
an outdoor air wetbulb temperature.

6. The method of claim 1, wherein training the at least one equipment-level artificial intelligence model, generating the central plant optimizer training data, and training the plant-level artificial intelligence model are performed within a cluster of computers and operating the equipment of the central plant is performed by an edge device.

7. The method of claim 6, wherein a form of the plant-level artificial intelligence model is stored in the edge device and parameters for the plant-level artificial intelligence model are provided to the edge device from the cluster of computers.

8. The method of claim 1, further comprising receiving recent operational data and training the at least one equipment-level artificial intelligence model using the recent operational data.

9. The method of claim 1, further comprising using the at least one equipment-level artificial intelligence model to estimate savings realized by operating the equipment according to the current plant operating targets.

10. A system for improving efficiency of a central plant, the system comprising:
one or more memory devices having instructions stored thereon that, when executed by one or more processors, cause the one or more processors to perform operations comprising:
generating an optimization problem, wherein the optimization problem comprises a constraint based on at least one equipment-level artificial intelligence model or an objective function based on the at least one equipment-level artificial intelligence model;
solving the optimization problem to obtain central plant optimizer training data;
training a plant-level artificial intelligence model to approximate solutions to the optimization problem using the central plant optimizer training data; and
operating equipment of the central plant based on current plant operating targets generated by evaluating the plant-level artificial intelligence model.

11. The system of claim 10, the operations further comprising providing uncontrolled operating conditions of the central plant, wherein solving the optimization problem comprises at least one of (i) using the uncontrolled operating conditions of the central plant to generate a second constraint or (ii) basing the objective function on the uncontrolled operating conditions of the central plant, and wherein the central plant optimizer training data comprises respective plant operating targets for the uncontrolled operating conditions of the central plant.

12. The system of claim 11, wherein the current plant operating targets comprise at least one of:
a target condenser water flow through a chiller;
a target exiting condenser water temperature for the chiller;
a target exiting condenser water temperature for a cooling tower;
a target exiting evaporator water temperature for the chiller;
a target speed for a condenser water pump; or
a target speed for a cooling tower fan.

13. The system of claim 11, wherein the uncontrolled operating conditions of the central plant comprise at least one of:
a required production of the central plant;
an outdoor air temperature; or
an outdoor air wetbulb temperature.

14. The system of claim 10, wherein training the at least one equipment-level artificial intelligence model, generating the central plant optimizer training data, and training the plant-level artificial intelligence model are performed within a cluster of computers and operating the equipment of the central plant is performed by an edge device.

15. The system of claim 14, wherein a form of the plant-level artificial intelligence model is stored in the edge device and parameters for the plant-level artificial intelligence model are provided to the edge device from the cluster of computers.

16. The system of claim 10, the operations further comprising using the at least one equipment-level artificial intelligence model to estimate savings realized by operating the equipment according to the current plant operating targets.

17. A building controller configured to improve efficiency of a central plant, the building controller comprising:
one or more memory devices having a model form of a plant-level artificial intelligence model stored thereon, the plant-level artificial intelligence model configured to accept uncontrolled operating conditions of the central plant as an input and produce plant operating targets as an output,
wherein the one or more memory devices have instructions stored thereon that, when executed by one or more processors, cause the one or more processors to perform operations comprising:
evaluating current uncontrolled operating conditions of the central plant using the plant-level artificial intelligence model to obtain current plant operating targets; and
operating the central plant based on the current plant operating targets,
wherein the plant-level artificial intelligence model is trained to approximate solutions to an optimization problem using central plant optimizer training data;
wherein the central plant optimizer training data is created by solving the optimization problem to obtain respective plant operating targets for uncontrolled operating conditions of the central plant.

18. The building controller of claim 17, the operations further comprising:
receiving parameters for the plant-level artificial intelligence model;
receiving current sensor data comprising current uncontrolled operating conditions of the central plant; and
receiving recent operational data and training the plant-level artificial intelligence model using the recent operational data.

19. The building controller of claim 17, the operations further comprising using the plant-level artificial intelligence model to estimate savings realized by operating the central plant according to the current plant operating targets.

20. The building controller of claim 17, wherein the current plant operating targets comprise at least one of:
a target condenser water flow through a chiller;
a target exiting condenser water temperature for the chiller;
a target exiting condenser water temperature for a cooling tower;
a target exiting evaporator water temperature for the chiller;
a target speed for a condenser water pump; or
a target speed for a cooling tower fan.
